(19) United States
(12) Patent Application Publication
(10) Pub. No.: US 2015/0234111 A1
(43) Pub. Date: Aug. 20, 2015

(54) BACKLIGHT UNIT

(71) Applicant: Samsung Display Co., Ltd., Yongin-City (KR)

(72) Inventors: Dong Hyeon Lee, Seoul (KR); Jun Woo You, Seongnam-si (KR); Dong Hoon Kim, Suwon-si (KR); Seung Hwan Baek, Seoul (KR)

(73) Assignee: Samsung Display Co., Ltd., Yongin-City (KR)

(21) Appl. No.: 14/295,029

(22) Filed: Jun. 3, 2014

(30) Foreign Application Priority Data
Feb. 14, 2014 (KR) 10-2014-0017210

(51) Int. Cl. F21V 8/00; G02F 1/1335; F21V 23/00; F21K 99/00

(52) U.S. Cl. CPC G02B 6/0026; F21K 9/56; G02F 1/1336; F21V 23/005; G02B 6/0088

(57) ABSTRACT

A backlight unit includes a light guide plate (LGP), one or more light-emitting devices disposed to face a side of the LGP and configured to generate light, a circuit board electrically connected to the one or more light-emitting devices, a quantum dot bar interposed between the LGP and the one or more light-emitting devices and configured to convert a wavelength of light, and a housing configured to house the one or more light-emitting devices, the circuit board and the quantum dot bar, and comprising first and second open end portions and an open side portion through which a portion of the LGP is inserted. The backlight unit further includes first and second covers covering the first and second open end portions of the housing, respectively, and coupled to the housing. The first cover and the second cover respectively include a first coupling portion and a second coupling portion which are coupled to first and second ends of the quantum dot bar, respectively.

This application claims priority from Korean Patent Application No. 10-2014-0017210 filed on Feb. 14, 2014 in the Korean Intellectual Property Office, the disclosure of which is incorporated herein by reference in its entirety.

### BACKGROUND

1. Field

The present disclosure relates to a backlight unit.

2. Description of the Related Art

Liquid crystal displays (LCDs) are of great importance in information display technology. An LCD includes two glass substrates and liquid crystals inserted between the two glass substrates. The LCD displays information by injecting electrodes through power sources disposed on and under the glass substrates and converting the electrodes into light using the liquid crystals.

The LCD is a light-receiving device that cannot emit light by itself and displays an image by controlling transmittance of light received from an external source. Therefore, the LCD requires a device for irradiating light to a display panel, that is, a backlight unit.

Currently, a light-emitting diode (LED) is drawing a lot of attention as a light source of a backlight unit of an LCD. The LED is a semiconductor light-emitting device that emits light when an electric current flows therethrough. Due to their long life, low power consumption, fast response speed, and superior initial driving characteristics, LEDs are being widely used as backlight units of lighting devices, electronic display boards and displays, and their field of application is expanding gradually.

When an LED light source is used, quantum dots may be used to increase the purity of color. The quantum dots generate light when unstable (excited) electrons fall from a conduction band to a valence band. Even if made of the same material, the quantum dots may generate light of a different wavelength according to their particle size. For example, the quantum dots generate light with a shorter wavelength when their particle size is smaller. Therefore, light in desired wavelength regions can be generated by controlling the size of the quantum dots, and white light can be produced by mixing the generated light.

In this regard, research is being conducted to produce white light of high color reproducibility by using a quantum dot material.

### SUMMARY

Aspects of the present invention provide a backlight unit which can produce white light of high color reproducibility.

Aspects of the present invention also provide a backlight unit which can prevent a quantum dot bar from being damaged by the expansion of a light guide plate (LGP).

Aspects of the present invention also provide a backlight unit which can be assembled easily.

However, aspects of the present invention are not restricted to the one set forth herein. The above and other aspects of the present invention will become more apparent to one of ordinary skill in the art to which the present invention pertains by referencing the detailed description of the present invention given below.

One aspect of the invention provides a backlight unit comprising: a light guide plate (LGP); one or more light-emitting devices disposed to face a side of the LGP and configured to emit generate light; a circuit board electrically connected to the one or more light-emitting devices; a quantum dot bar interposed between the LGP and the one or more light-emitting devices and configured to convert a wavelength of light; a housing configured to house the one or more light-emitting devices, the circuit board and the quantum dot bar, and comprising first and second open end portions and an open side portion through which a portion of the LGP is inserted; and first and second covers covering the first and second open end portions of the housing, respectively, and coupled to the housing, wherein the first cover and the second cover respectively comprise a first coupling portion and a second coupling portion which are coupled to first and second ends of the quantum dot bar, respectively.

In the foregoing backlight unit, the backlight unit may further comprise an adhesive member which is interposed between the circuit board and the housing to couple the circuit board and the housing. At least one of the first cover and the second cover comprises a through hole through which a portion of the circuit board pass, wherein the portion of the circuit board protrudes out of the at least one of the first cover and the second cover. Each of the first cover and the second cover may comprise a recessed shape corresponding to a vertical cross-sectional shape of a portion of the housing which is coupled to each of the first cover and the second cover. The housing may comprise a protruding portion which protrudes downward to provide a space within the housing such that the circuit board can rotate in the space. The housing may further comprise an upper support portion and a lower support portion which protrude inward, wherein the upper support portion and the lower support portion protrude toward the quantum dot bar from above and under a location where the quantum dot bar is disposed, wherein the upper support portion and the lower support portion contact the quantum dot bar.

Still in the foregoing backlight unit, the housing may have a length and a sectional shape taken in a plane perpendicular to its length direction is uniform throughout the length. The housing may comprise an upper inner surface and a lower inner surface which contact upper and lower surfaces of the quantum dot bar such that a substantial amount of light does not transmit between the upper inner surface of the housing and the upper surface of the quantum dot bar and a substantial amount of light does not transmit between the lower inner surface of the housing and the lower surface of the quantum dot bar. The housing may comprise an upper groove and a lower groove extending in a length direction of the housing and comprising the upper inner surface and the lower inner surface, respectively. The housing may comprise an upper protrusion and a lower protrusion protruding toward the quantum dot bar, extending in a length direction of the housing and comprising the upper inner surface and the lower inner surface, respectively.

Yet in the foregoing backlight unit, the housing may comprise a first bent surface and a second bent surface which extend inward toward the LGP, wherein the first bent surface extends from above the LGP toward an upper surface of the LGP, and the second bent surface extends from under the LGP toward a lower surface of the LGP. The housing may comprises a first parallel surface which is connected to the first bent surface and parallel to the LGP; a second parallel surface which is connected to the second bent surface and parallel to the LGP; a first bending portion which is connected to the first parallel surface and extends outward of the housing; and a second bending portion which is connected to the second parallel surface and extends outward of the housing, wherein the first parallel surface and the second parallel surface contact the LGP. The housing may comprise a first guide groove and a second guide groove which guide the quantum dot bar to be placed therein, wherein the first guide groove is disposed on an upper surface of the quantum dot bar, and the second guide groove is disposed on a lower surface of the quantum dot bar. The LGP may comprise an insertion portion which is inserted into the open side portion and a step which causes the other portion of the LGP to be wider than the open side portion.

Another aspect of the invention provides a backlight unit comprising: a light guide plate (LGP); one or more light-emitting devices disposed to face a side of the LGP and configured to generate light; a circuit board electrically connected to the one or more light-emitting devices; a quantum dot bar interposed between the LGP and the one or more light-emitting devices and configured to convert a wavelength of light; a housing configured to house the quantum dot bar and comprises first and second open end portions, an open side portion through which a portion of the LGP is inserted, and one or more incident windows respectively corresponding to the one or more light-emitting devices; and a first cover and a second cover covering the first and second open end portions of the housing, respectively, and coupled to the housing, wherein the first cover and the second cover respectively comprise a first coupling portion and a second coupling portion which are coupled to first and second ends of the quantum dot bar, respectively, and wherein the one or more light-emitting devices are respectively inserted into the one or more incident windows. In the foregoing backlight unit, the housing may comprise a first bent surface which extends from above the LGP toward an upper surface of the LGP; a second bent surface which extends from under the LGP toward a lower surface of the LGP; a first parallel surface which is connected to the first bent surface and parallel to the LGP; and a second parallel surface which is connected to the second bent surface and parallel to the LGP, wherein the first parallel surface and the second parallel surface contact the LGP.

A further aspect of the invention provides a backlight unit comprising: a circuit board; a plurality of light-emitting devices electrically connected to the circuit board and arranged along a length direction of the circuit board; an light guide plate (LGP) comprising a side facing the plurality of light-emitting devices; a quantum dot bar interposed between the one or more light-emitting devices and the LGP and configured to convert a wavelength of light; a housing configured to house the circuit board and the quantum dot bar, and comprising first and second open end portions and an open side portion through which a portion of the LGP is inserted; and a first cover and a second cover covering the open end portions, respectively, and coupled to the housing, wherein the first cover and the second cover respectively comprise a first coupling portion and a second coupling portion coupled to both ends of the quantum dot bar, respectively.

In the foregoing backlight unit, the housing may comprise a first guide groove and a second guide groove which guide the quantum dot bar to be placed therein, wherein the first guide groove is disposed on an upper surface of the quantum dot bar, and the second guide groove is disposed on a lower surface of the quantum dot bar. The housing may comprise a fixing portion which fixes the circuit board to the housing. The fixing portion may comprise a first hook which is disposed on an upper surface of the circuit board to cover the circuit board and a second hook which is disposed on a lower surface of the circuit board to cover the circuit board.

An aspect of the present invention provides a backlight unit comprising a light guide plate (LGP), one or more light-emitting devices which are disposed on a side of the LGP and generate light, a circuit board which is electrically connected to the light-emitting devices, a quantum dot bar which is interposed between the LGP and the light-emitting devices and converts a wavelength of light, a light source cover which surrounds and houses the light-emitting devices, the circuit board and the quantum dot bar and comprises open portions at both ends thereof in a lengthwise direction of the quantum dot bar and an open side portion into which a portion of the LGP is inserted, and a first cover and a second cover which cover the open portions at both ends of the light source cover and are coupled to the light source cover, wherein the first cover and the second cover respectively comprise a first coupling portion and a second coupling portion which are coupled to both sides of the quantum dot bar.

The backlight unit may further comprise an adhesive member which is interposed between the circuit board and the light source cover and couples the circuit board and the light source cover.

At least one of the first cover and the second cover may comprise a through hole through which a portion of the circuit board can pass, wherein the portion of the circuit board passes through the through hole to protrude out of at least one of the first cover and the second cover.

Each of the first cover and the second cover may comprise an intaglio shape corresponding to a vertical cross-sectional shape of a portion of the light source cover which is coupled to each of the first cover and the second cover.

The light source cover may comprise a protruding portion which protrudes downward, wherein the protruding portion protrudes downward at a location where the circuit board is disposed.

The first cover and the second cover may comprise a first protruding portion and a second protruding portion which protrude downward to correspond to the protruding portion of the light source, cover.

The light source cover may further comprise an upper support portion and a lower support portion which protrude inward, wherein the upper support portion and the lower support portion may protrude toward the quantum dot bar from above and under a location where the quantum dot bar is disposed.

The upper support portion and the lower support portion may contact the quantum dot bar.

The light source cover may comprise a first bent surface and a second bent surface which extend inward toward the LGP, wherein the first bent surface may extend from above the LGP toward an upper surface of the LGP, and the second bent surface may extend from under the LGP toward a lower surface of the LGP.

The light source cover may comprise a first parallel surface which is connected to the first bent surface and parallel to the LGP, and a second parallel surface which is connected to the second bent surface and parallel to the LGP, wherein the first parallel surface and the second parallel surface may contact the LGP.

The light source cover may comprise a first bending portion and a second bending portion which extend outward at a location where the open side portion is disposed, wherein the first bending portion may be disposed on the upper surface of the LGP, and the second bending portion may be disposed on the lower surface of the LGP.

The light source cover may comprise a first parallel surface which is connected to the first bent surface and parallel to the LGP, a second parallel surface which is connected to the second bent surface and parallel to the LGP, a first bending portion which is connected to the first parallel surface and extends outward of the light source cover, and a second bending portion which is connected to the second parallel surface and extends outward of the light source cover, wherein the first parallel surface and the second parallel surface may contact the LGP.

The light source cover may comprise a first guide groove and a second guide groove which guide the quantum dot bar to be placed therein, wherein the first guide groove may be disposed on an upper surface of the quantum dot bar, and the second guide groove may be disposed on a lower surface of the quantum dot bar.

The LGP may comprise an insertion portion which is inserted into the open side portion and a step which causes the other portion of the LGP to be wider than the open side portion.

Another aspect of the present invention provides a backlight unit comprising an LGP, one or more light-emitting devices which are disposed on a side of the LGP and generate light, a circuit board which is electrically connected to the light-emitting devices, a quantum dot bar which is interposed between the LGP and the light-emitting devices and converts a wavelength of light, a light source cover which houses the quantum dot bar and comprises open portions at both ends thereof in a lengthwise direction of the quantum dot bar, an open side portion into which a portion of the LGP is inserted, and one or more incident windows respectively corresponding to the light-emitting devices, and a first cover and a second cover which cover the open portions at both ends of the light source cover and are coupled to the light source cover, wherein the first cover and the second cover may comprise a first coupling portion and a second coupling portion which are coupled to both sides of the quantum dot bar, and the light-emitting devices are respectively inserted into the incident windows.

The light source cover may comprise a first bent surface which extends from above the LGP toward an upper surface of the LGP, a second bent surface which extends from under the LGP toward a lower surface of the LGP, a first parallel surface which is connected to the first bent surface and parallel to the LGP, and a second parallel surface which is connected to the second bent surface and parallel to the LGP, wherein the first parallel surface and the second parallel surface may contact the LGP.

Still another aspect of the present invention provides a backlight unit comprising a circuit board, a plurality of light-emitting devices which are electrically connected to the circuit board and arranged in a direction of the circuit board, an LGP which is disposed on a side of each of the light-emitting devices, a quantum dot bar which is interposed between the light-emitting devices and the LGP and converts a wavelength of light, a light source cover which fixes and houses the circuit board, houses the quantum dot bar, and comprises open portions at both ends thereof in a lengthwise direction of the quantum dot bar and an open side portion into which a portion of the LGP is inserted, and a first cover and a second cover which cover the open portions at both ends of the light source cover and are coupled to the light source cover, wherein the first cover and the second cover may comprise a first coupling portion and a second coupling portion which are coupled to both sides of the quantum dot bar.

The light source cover may comprise a first guide groove and a second guide groove which guide the quantum dot bar to be placed therein, wherein the first guide groove may be disposed on an upper surface of the quantum dot bar, and the second guide groove may be disposed on a lower surface of the quantum dot bar.

The light source cover may comprise a fixing portion which fixes the circuit board to the light source cover.

The fixing portion may comprise a first hook which is disposed on an upper surface of the circuit board to cover the circuit board and a second hook which is disposed on a lower surface of the circuit board to cover the circuit board.

Other features and aspects will be apparent from the following detailed description, the drawings, and the claims.

### BRIEF DESCRIPTION OF THE DRAWINGS

The above and other aspects and features of the present invention will become more apparent by describing in detail exemplary embodiments thereof with reference to the attached drawings, in which:

FIG. 1 is a perspective view of a backlight unit according to an embodiment of the present invention;

FIG. 2 is a perspective view of the backlight unit of FIG. 1 excluding a light guide plate (LGP);

FIG. 3 is a partial perspective view of the backlight unit of FIG. 1 excluding a first cover;

FIG. 4 is a cross-sectional view of the backlight unit taken along the line A-A′ of FIG. 3;

FIG. 5 is an enlarged perspective view of a portion ‘B’ of FIG. 1;

FIG. 6 is a cross-sectional view of a housing according to another embodiment of the present invention;

FIG. 7 is a cross-sectional view of a housing according to another embodiment of the present invention;

FIG. 8 is a rear view of a first cover according to an embodiment of the present invention;

FIG. 9 is a front view of the first cover of FIG. 8;

FIG. 10 is a perspective view of a first cover according to another embodiment of the present invention;

FIG. 11 is a partial perspective view of a backlight unit according to another embodiment of the present invention;

FIG. 12 is a cross-sectional view of a backlight unit according to another embodiment of the present invention;

FIGS. 13 through 21 are views illustrating a process of assembling a backlight unit according to an embodiment of the present invention;

FIG. 22 is a cross-sectional view of a backlight unit according to another embodiment of the present invention;

FIG. 23 is a cross-sectional view of a backlight unit according to another embodiment of the present invention;

FIG. 24 is a partial perspective view of the backlight unit of FIG. 23;

FIG. 25 is a partial perspective view of a housing according to another embodiment of the present invention; and

FIGS. 26 through 28 are cross-sectional views of backlight units according to other embodiments of the present invention.

### DETAILED DESCRIPTION OF EMBODIMENTS

The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims.

The term “on” that is used to designate that an element is on another element or located on a different layer or a layer includes both a case where an element is located directly on another element or a layer and a case where an element is located on another element via another layer or still another element. In the entire description of the present application, the same drawing reference numerals are used for the same elements across various figures.

Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element.

Hereinafter, embodiments of the present invention will be described with reference to the accompanying drawings.

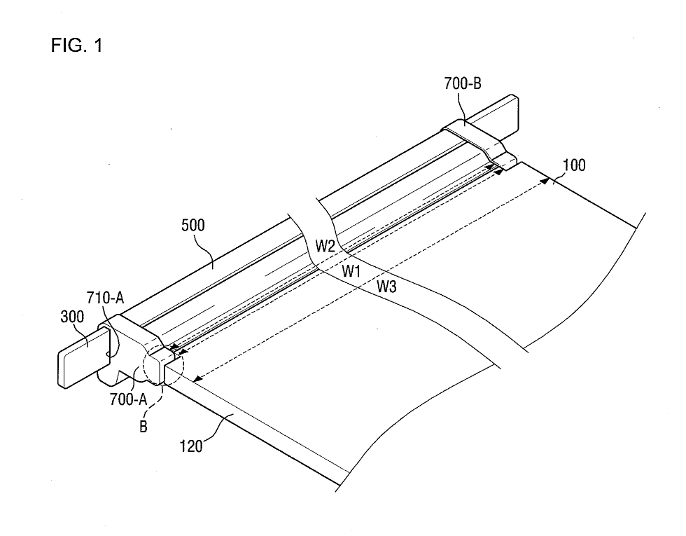

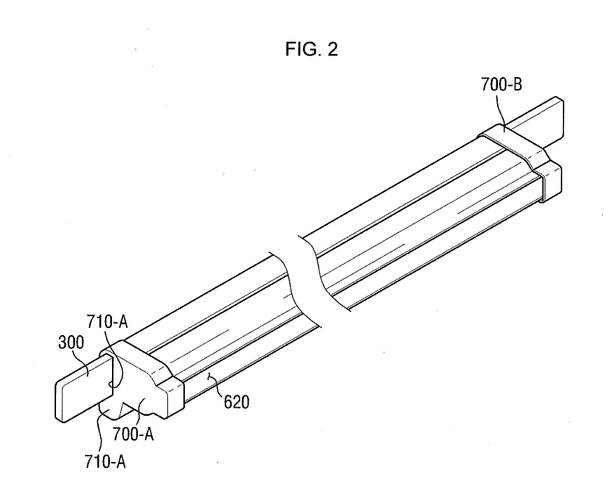

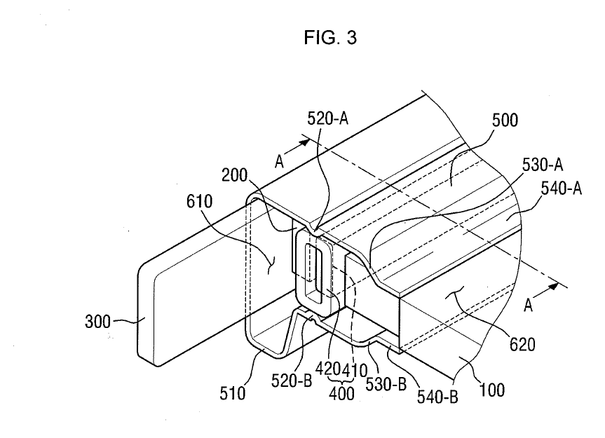

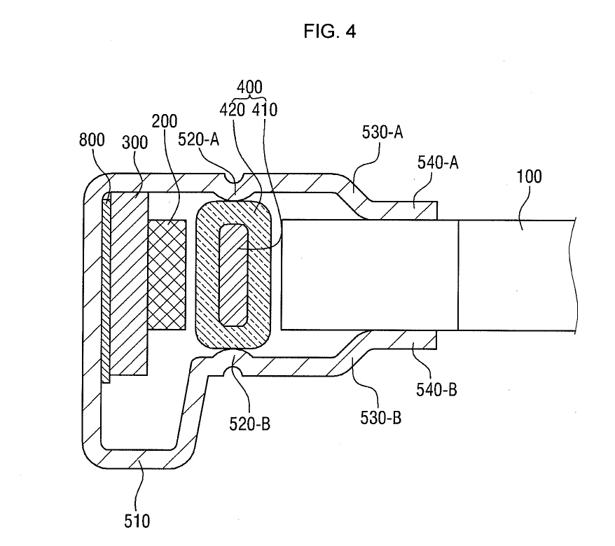

FIG. 1 is a perspective view of a backlight unit according to an embodiment of the present invention. FIG. 2 is a perspective view of the backlight unit of FIG. 1 excluding a light guide plate (LGP) 100. FIG. 3 is a perspective view of the backlight unit of FIG. 1 excluding a first cover 700-A. FIG. 4 is a cross-sectional view of the backlight unit taken along the line A-A′ of FIG. 3.

Referring to FIGS. 1 through 4, the backlight unit according to the current embodiment may include the LGP 100; one or more light-emitting devices 200 which face a side of the LGP 100 and generate and emit light to the side of the LGP; a circuit board 300 which is electrically connected to the light-emitting devices 200; a quantum dot bar 400 which is interposed between the LGP 100 and the light-emitting devices 200 and converts a wavelength of light; a housing or light source cover 500 which surrounds and houses the light-emitting devices 200, the circuit board 300 and the quantum dot bar 400 and includes open end portions 610 at both ends thereof in a lengthwise direction of the quantum dot bar 400 and an open side portion 620 into which a portion of the LGP 100 is inserted; and the first cover 700-A and a second cover 700-B which cover the open portions 610 at both ends of the housing or a cover frame 500 and are coupled to the housing 500. In addition, the first cover 700-A and the second cover 700-B may respectively include a first coupling portion (not shown) and a second coupling portion (not shown) which are coupled to both side surfaces of the quantum dot bar 400.

The LGP 100 may convert light incident on a side surface thereof into flat light by reflecting, refracting and scattering the incident light, so that the flat light can emerge upward from the LGP 100. The LGP 100 may be made of but not limited to, polymethyl methacrylate resin, polycarbonate resin, acrylonitrile-styrene-butadiene copolymer resin, polystyrene resin, acrylonitrile-styrene copolymer resin, polyolefin resin, or polymethacryl styrene resin obtained by mixing polymethyl methacrylate and polystyrene. The LGP 100 may be shaped like a wedge that becomes thinner as the distance from a light source increases or may be shaped like a plate having parallel upper and lower surfaces. The shape of the LGP 100 can be changed as desired by those of ordinary skill in the art to which the present invention pertains.

The light-emitting devices 200 disposed on the circuit board 300 may be electrically connected to the circuit board 300. The light-emitting devices 200 may be separated from each other in a direction of the circuit board 300. Each of the light-emitting devices 200 may include a light-emitting diode (LED) package and the LED package may be mounted on the circuit board 300 by chip-on-board (COB) technology. When each of the light-emitting devices 200 is formed as an LED package, the LED package may include an LED chip disposed within a molding frame and encapsulated by an encapsulant.

Each of the light-emitting devices 200 may emit light when receiving an electrical signal from the circuit board 300. The circuit board 300 may include a circuit pattern (not shown) in order to transmit electrical signals to the light-emitting devices 200. The circuit pattern may be made of a metal material having superior electrical conductivity and thermal conductivity, such as gold (Au), silver (Ag), or copper (Cu).

The circuit board 300 may be a printed circuit board (PCB) or may be made of an organic resin material containing epoxy, triazine, silicon and polyimide, and other organic resin materials. The circuit board 300 may also be a flexible printed circuit board (FPCB) or a metal core printed circuit board (MCPCB).

Each of the light-emitting devices 200 may include a blue LED chip or an ultraviolet (UV) LED chip. Light emitted from each of the light-emitting devices 200 may pass through the quantum dot bar 400 and emerge from the quantum dot bar 400 as high-purity white light.

The circuit board 300 may be disposed inside the housing 500 to be perpendicular to a sidewall of the housing 500. In other words, referring to FIG. 4, the circuit board 300 may be disposed on an inner surface of a left sidewall of the housing 500. The circuit board 300 may further include an adhesive member 800 which is interposed between the housing 500 and the circuit board 300 to couple the circuit board 300 and the housing 500. Examples of the adhesive member 800 may include, but not limited to, a heat-dissipation tape, a double-sided tape, resin, urethane, and other adhesives.

The quantum dot bar 400 may be disposed between the LGP 100 and the light-emitting devices 200 and may be separated from the light-emitting devices 200 and the LGP 100 by certain distances. That is, referring to FIG. 4, the circuit board 300 to which the light-emitting elements 200 are electrically connected may be disposed on the inner surface of the left sidewall of the housing 500 in a direction perpendicular to a horizontal surface. Therefore, the light-emitting devices 200 may be disposed on a right side surface of the circuit board 300. The quantum dot bar 400 and the LGP 100 may be arranged sequentially to neighbor a side of each of the light-emitting devices 200, that is, a side opposite the side on which the circuit board 300 is disposed. In FIGS. 1 through 4, the housing 500, the light-emitting devices 200, the quantum dot bar 400, etc. are arranged sequentially in this order on a left side of the LGP 100. However, if they are arranged on a right side of the LGP 100, their arrangement order may be reversed.

The quantum dot bar 400 may produce white light by converting the wavelength of light incident from the light-emitting devices 200. To this end, the quantum dot bar 400 may include a quantum dot tube 420 and a quantum dot material 410 contained in the quantum dot tube 420. In other words, the quantum dot bar 400 may be shaped like a bar extending along one direction and may contain the quantum dot material 410 in the hollow quantum dot tube 420. The quantum dot tube 420 may be filled and sealed with a mixture of a polymer material and the quantum dot material 410.

The quantum dot material 410 emits light when excited electrons fall from a conduction band to a valence band. Even if made of the same material, the quantum dot material 410 may emit light having a different wavelength according to its particle size. For example, the quantum dot material 410 generates light having a shorter wavelength when its size is smaller. Therefore, light in a desired wavelength region can be obtained by controlling the size of the quantum dot material 410.

The quantum dot material 410 has a particle size of 10 nm or less. For example, the quantum dot material 410 may emit red-based light when having a particle size of 55 to 65 Å, emit green-based light when having a particle size of 40 to 50 Å, and emit blue-based light when having a particle size of 20 to 35 Å. Yellow light may be emitted from the quantum dot material 410 whose particle size is in the middle between the particle size of the quantum dot material 410 which emits red light and the particle size of the quantum dot material 410 which emits green light.

To form the quantum dot bar 400 which emits white light, if each of the light-emitting devices 200 includes a UV LED chip, three types of quantum dot materials 410 which respectively receive UV light and emit red, blue and green light may be mixed and then injected into the quantum dot tube 420. If each of the light-emitting devices 200 includes a blue LED chip, two types of quantum dot materials 410 which respectively receive blue light and emit red light and green light may be mixed and injected into the quantum dot tube 420. In this way, the quantum dot material 410 may be adjusted according to the type of the light-emitting devices 200 in order to produce white light of high color reproducibility.

The quantum dot material 410 may include any one nanocrystal selected from the group consisting of a Si nanocrystal, a group II-VI compound semiconductor nanocrystal, a group III-V compound semiconductor nanocrystal, a group IV-VI compound semiconductor nanocrystal, and a mixture of the same.

The group II-VI compound semiconductor nanocrystal may be any one selected from the group consisting of CdS, CdSe, CdTe, ZnS, ZnSe, ZnTe, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HggZnTe, CdZnSeS, CdZnSeTe, CdZnSTe, CdHgSeS, CdHgSeTe, CdHgSTe, HgZnSeS, HgZnSeTe, and HgZnSTe.

The group III-V compound semiconductor nanocrystal may be any one selected from the group consisting of GaPAs, AlNP, AlNAs, AlPAs, InNP, InNAs, InPAs, GaAlNP, GaAlNAs, GaAlPAs, GaInNP, GaInNAs, GaInPAs, InAlNP, InAlNAs, and InAlPAs.

The group IV-VI compound semiconductor nanocrystal may be SbTe.

The quantum dot bar 400 and the light-emitting devices 200 may be separated by a certain distance. Each of the light-emitting devices 200 may emit light in response to an electrical signal received from the circuit board 300, thereby generating heat. The heat can reduce the wavelength convertibility of the quantum dot material 410 included in the quantum dot bar 400. Therefore, the light-emitting devices 200 and the quantum dot bar 400 may be separated by a certain distance in order to reduce the amount of heat transmitted from the light-emitting devices 200 to the quantum dot bar 400.

The quantum dot bar 400 may also be separated from the LGP 100 by a certain distance. Since the quantum dot tube 420 that forms an outer wall of the quantum dot bar 400 is made of a brittle material such as glass, it can be damaged by external impact, resulting in the leakage of the quantum dot material 410 inside the quantum dot tube 420. In particular, the material that forms the quantum dot material 410 may contain an environmental pollutant such as Cd. Therefore, when the quantum dot tube 420 is broken, environmental pollution may occur as well as a problem with a product.

The LGP 100 may expand with heat generated when the backlight unit is used or may expand with external heat. When the LGP 100 expands, it may impact on the quantum dot bar 400, thereby damaging the quantum dot bar 400. Therefore, the quantum dot bar 400 and the LGP 100 may be separated by a certain distance so as to prevent the damage to the quantum dot bar 400 by the expansion of the LGP 100.

The housing 500 may house the light-emitting devices 200, the circuit board 300 and the quantum dot bar 400 by surrounding them. The housing 500 may include the open portions 610 at both ends thereof in the lengthwise direction of the quantum dot bar 400 and the open side portion 620 into which a portion of the LGP 100 is inserted. That is, the housing 500 may cover an upper surface of a portion of the LGP 100 which is inserted into the housing 500, an upper surface of the quantum dot bar 400, upper surfaces of the light-emitting devices 200, an upper surface of the circuit board 300, a surface of the circuit board 300 which is opposite the surface on which the light-emitting devices 200 are disposed, a lower surface of the circuit board 300, lower surfaces of the light-emitting devices 200, a lower surface of the quantum dot bar 400, and a lower surface of the portion of the LGP 100.

In other words, the housing 500 may surround the above elements such that it includes the open portions 610 at both ends of the quantum dot bar 400 in the lengthwise direction of the quantum dot bar 400 and the open side portion 620 into which a portion of the LGP 100 can be inserted.

The backlight unit may include the first cover 700-A and the second cover 700-B which cover the open portions 610 at both ends of the housing 500 and are coupled to the housing 500. In FIG. 2, the housing 500 into which the LGP 100 has not yet been inserted is illustrated. Referring to FIG. 2, since the open portions 610 at both ends of the housing 500 are covered by the first cover 700-A and the second cover 700-B, only the open side portion 620 into which the LGP 100 can be inserted is exposed. Therefore, if the LGP 100 is inserted into the open side portion 620, most of light emitted from inside the housing 500 may proceed toward a side surface of the LGP 100. This can increase the efficiency of light emitted from the light-emitting devices 200.

As for the coupling relationship between the housing 500 and the first cover 700-A and the second cover 700-B, the first cover 700-A and the second cover 700-B may partially cover the housing 500 by respectively covering the open portions 610 at both sides of the housing 500. For this coupling, each of the first cover 700-A and the second cover 700-B may include an intaglio shape corresponding to the shape of a vertical cross-section of a portion of the housing 500 which is coupled to each of the first cover 700-A and the second cover 700-B. In other words, each of the first cover 700-A and the second cover 700-B may include an intaglio shape corresponding to a vertical cross-sectional shape of the housing 500 having the open portions 610. Therefore, the housing 500 may be inserted and coupled to the intaglio shape formed in each of the first cover 700-A and the second cover 700-B.

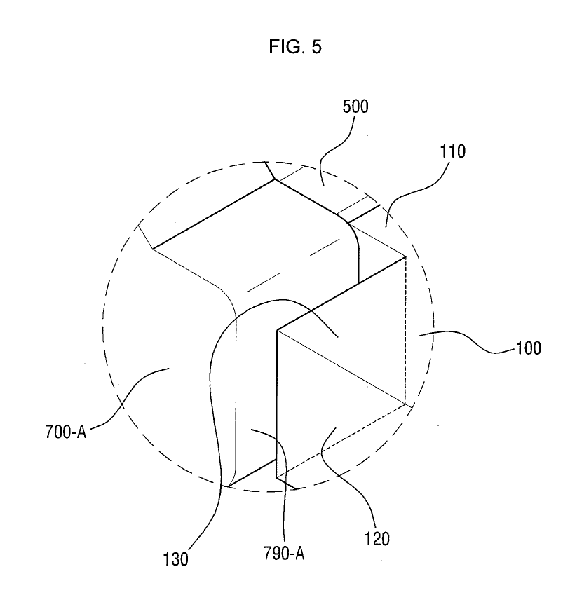

FIG. 5 is an enlarged perspective view of a portion ‘B’ of FIG. 1. Referring to FIG. 5, each of the first cover 700-A and the second cover 700-B may include a blocking surface 790-A that block both ends of the open side portion 620 of the light source cover 500. Due to the blocking surface 790-A, only a region of the LGP 100 can be inserted into the housing 500. The blocking surface 790-A may guide the LGP 100 to be accurately inserted into a desired location in the housing 500. The relationship between the blocking surface 790-A and the LGP 100 will be described in greater detail later.

Referring back to FIG. 2, at least one of the first cover 700-A and the second cover 700-B may include a through hole 720-A or 720-B through which a portion of the circuit board 300 can pass. A portion of the circuit board 300 may pass through the through hole 720-A or 720-B to protrude out of at least one of the first cover 700-A and the second cover 700-B.

The shape and size of the through hole 720-A or 720-B may correspond to the shape and the size of the circuit board 300. The circuit board 300 may be passed through the through hole 720-A or 720-B and fixed to the through hole 720-A or 720-B. In addition, if the through holes 720-A and 720-B are formed in both the first cover 700-A and the second cover 700-B, the circuit board 300 may be fixed at both side surfaces of the housing 500.

The first cover 700-A and the second cover 700-B respectively include the first coupling portion and the second coupling portion which are coupled to both side surfaces of the quantum dot bar 400. Accordingly, the quantum dot bar 400 is fixed in position. That is, the quantum dot bar 400 is fixed in position by the first coupling portion and the second coupling portion of the first cover 700-A and the second cover 700-B located at both ends of the quantum dot bar 400 in the lengthwise direction of the quantum dot bar 400. Therefore, the movement of the quantum dot bar 400 within the housing 500 can be prevented even without using an adhesive member. The first coupling portion and the second coupling portion will be described in greater detail later.

Referring to FIG. 4, the housing 500 may include a protruding portion 510 which protrudes downward. The protruding portion 510 may protrude downward at a location where the circuit board 300 is disposed.

Although not illustrated in the drawing, the backlight unit may be disposed on a bottom chassis which includes a bottom surface and a plurality of sidewalls surrounding the bottom surface. The LGP 100 may be disposed on the bottom surface of the bottom chassis. When the backlight unit is housed in the bottom chassis, the downwardly protruding portion 510 of the housing 500 may cause the light-emitting devices 200, the quantum dot bar 400, and a portion of the LGP 100, etc. inside the housing 500 to be placed higher than the bottom surface of the bottom chassis. That is, a path along which light emitted from the light-emitting devices 200 passes through the quantum dot bar 400 and enters the LGP 100 may be formed higher than the bottom surface of the bottom chassis.

In addition, since a portion of the LGP 100 is inserted into the housing 500 at a certain height from the bottom surface of the bottom chassis, the other portion of the LGP 100 which is not inserted into the housing 500 needs to be supported such that light passing through the quantum dot bar 400 after being emitted from the light-emitting devices 200 can enter the LGP 100. Therefore, the bottom surface of the bottom chassis on which the LGP 100 is placed may include a support portion which bulges toward the LGP 100. The support portion may protrude to a height high enough to place the LGP 100 in the same parallel line with the light-emitting devices 200 and the quantum dot bar 400.

Since the housing 500 includes the protruding portion 510 which protrudes downward and the bottom surface of the bottom chassis includes the support portion which supports the LGP 100, an empty space may be formed between the protruding portion 510 and the support portion. In other words, the protruding portion 510 may protrude downward at a location where the circuit board 300 is disposed, and an empty space may be formed under the quantum dot bar 400 interposed between the circuit board 300 and the LGP 100. That is, an empty space of a certain size may be formed between the outside of the housing 500 at a location where the quantum dot bar 400 is disposed and the bottom surface of the bottom chassis. Therefore, in a display device using the backlight unit, impact delivered from the outside can be cushioned by the empty space. Accordingly, it is possible to prevent external impact from being delivered as it is to the quantum dot bar 400 and thus breaking or damaging the quantum dot bar 400.

Referring back to FIG. 2, the first cover 700-A and the second cover 700-B may respectively include a first protruding portion 710-A and a second protruding portion 710-B which protrude downward to correspond to the protruding portion 510 of the housing 500.

The housing 500 will now be described in greater detail with reference to FIGS. 3 and 4. The housing 500 may include a first bent surface 530-A and a second bent surface 530-B which extend inward toward the LGP 100. The first bent surface 530-A may extend from above the LGP 100 toward an upper surface of the LGP 100, and the second bent surface 530-B may extend from under the LGP 100 toward a lower surface of the LGP 100.

In addition, the housing 500 may include a first parallel surface 540-A which is connected to the first bent surface 530-A and parallel to the LGP 100 and a second parallel surface 540-B which is connected to the second bent surface 530-B and parallel to the LGP 100. The first parallel surface 540-A and the second parallel surface 540-B may contact the LGP 100.

More specifically, the first bent surface 530-A and the first parallel surface 540-A may be formed from the housing 500 above the LGP 100 inserted into the housing 500. The first bent surface 530-A and the first parallel surface 540-A as a whole may be bent toward the LGP 100 inserted into the housing 500. In addition, the second bent surface 530-B and the second parallel surface 540-B as a whole may be bent from the housing 500 under the LGP 100 toward the LGP 100. In other words, a gap between the LGP 100 inserted into the housing 500 and the housing 500 above and under the LGP 100 may decrease toward the open side portion 620. That is, the gap between the LGP 100 and the housing 500 above and under the LGP 100 may gradually decrease from inside the housing 500 toward the open side portion 620.

The first bent surface 530-A and the second bent surface 530-B of the housing 500 make it possible to adjust a height of the open side portion 620 of the housing 500 substantially to a height of the LGP 100 inserted into the housing 500. Therefore, most of light emitted from the light-emitting devices 200 and then passing through the quantum dot bar 400 can enter a side surface of the LGP 100 inserted into the housing 500 through the open side portion 620. The first bent surface 530-A and the second bent surface 530-B can reduce an unnecessary space between the LGP 100 and the housing 500 and reduce the amount of light leaking out of the LGP 100. Thus, a large amount of light can be secured. In addition, the first parallel surface 540-A and the second parallel surface 540-B can support the LGP 100 inserted into the housing 500 on upper and lower sides of the LGP 100, respectively.

The housing 500 may further include an upper support portion 520-A and a lower support portion 520-B which protrude inward. The upper support portion 520-A and the lower support portion 520-B may protrude toward the quantum dot bar 400 from above and under a location where the quantum dot bar 400 is located. In addition, the upper support portion 520-A and the lower support portion 520-B may contact the quantum dot bar 400 and may be made of an elastic member.

The upper support portion 520-A and the lower support portion 520-B of the housing 500 may be made of the same material as the housing 500. The upper support portion 520-A and the lower support portion 520-B may be connected to the housing 500 or may be formed by bending or pressing the housing 500. If the upper support portion 520-A and the lower support portion 520-B are connected to the housing 500, the housing 500 may have elasticity. Therefore, the upper support portion 520-A and the lower support portion 520-B can prevent the quantum dot bar 400 from being damaged by external impact.

More specifically, the upper support portion 520-A and the lower support portion 520-B may lie in the same vertical line with respect to the quantum dot bar 400. The quantum dot bar 400 may have both ends coupled and fixed to the first cover 700-A and the second cover 700-B. In addition, the quantum dot bar 400 may be supported by the upper support portion 520-A and the second support portion 520-B disposed on and under the quantum dot bar 400 inside the housing 500. Therefore, it is possible to prevent light emitted from the light-emitting devices 200 from entering the LGP 100 without passing through the quantum dot bar 400. Accordingly, the wavelength of the light can be converted with high efficiency.

For example, when each of the light-emitting devices 200 includes a blue LED chip, it may emit blue light. Here, if the blue light passes through the quantum dot bar 400, it may be wavelength-converted into white light, and thus the white light may enter the LGP 100. However, if the blue light does not pass through the quantum dot bar 400, it may enter the LGP 100 as it is, and thus the blue light may be seen. Consequently, some blue light may be seen in the white light displayed on a display unit placed on the upper surface of the LGP 100, thereby causing color imbalance. However, the upper support portion 520-A and the lower support portion 520-B formed on and under the quantum dot bar 400 can prevent the blue light from leaking out as it is.

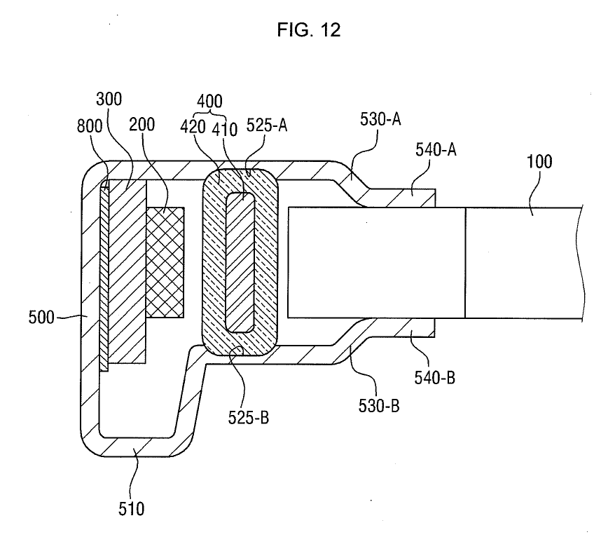

Referring to FIGS. 2, 3 and 4, in embodiments, the housing 500 has a length and a sectional shape taken in a plane perpendicular to its length direction is uniform throughout the length. In an embodiment, the housing includes an upper inner surface and a lower inner surface which contact upper and lower surfaces of the quantum dot bar such that a substantial amount of light does not transmit between the upper inner surface of the housing and the upper surface of the quantum dot bar and between the lower inner surface of the housing and the lower surface of the quantum dot bar. The housing 500 includes an upper protrusion 520-A and a lower protrusion 520-B protruding toward the quantum dot bar, extending in a length direction of the housing and comprising the upper inner surface and the lower inner surface, respectively. In an alternative embodiment, the housing includes an upper groove 525-A and a lower groove 525-B extending in a length direction of the housing and including the upper inner surface and the lower inner surface, respectively, which contact the upper and lower surfaces of the quantum dot bar, as illustrated in FIG. 12.

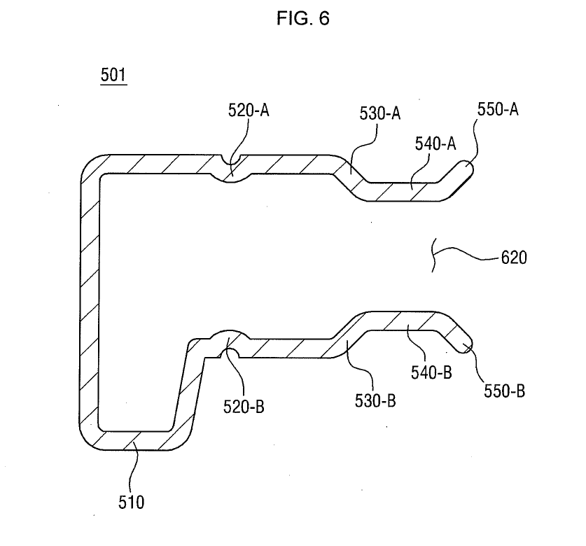

FIG. 6 is a cross-sectional view of a housing or light source cover 501 according to another embodiment of the present invention. Referring to FIG. 6, the housing 501 may include a first bending portion 550-A and a second bending portion 550-B which extend outward at a location where an open side portion 620 is located. The first bending portion 550-A may be disposed on the upper surface of the LGP 100, and the second bending portion 550-B may be disposed on the lower surface of the LGP 100.

The housing 501 may include a first parallel surface 540-A which is connected to a first bent surface 530-A and parallel to the LGP 100, a second parallel surface 540-B which is connected to a second bent surface 530-B and parallel to the LGP 100, the first bending portion 550-A which is connected to the first parallel surface 540-A and extends outward of the housing 501, and the second bending portion 550-B which is connected to the second parallel surface 540-B and extends outward of the housing 501. In addition, the first parallel surface 540-A and the second parallel surface 540-B may contact the LGP 100.

That is, the first bending portion 550-A and the second bending portion 550-B may respectively be connected to the first parallel surface 540-A and the second parallel surface 540-B and may extend outward of the housing 501 in a radial shape from locations where open portions 610 are formed. In other words, the first bending portion 550-A may extend from a location where the LGP 100 is inserted into the housing 501 in a direction upwardly away from the LGP 100, and the second bending portion 550-B may extend from the location where the LGP 100 is inserted into the housing 501 in a direction downwardly away from the LGP 100. That is, a distance between each of the first bending portion 550-A and the second bending portion 550-B and the LGP 100 may increase as a distance from each of the first parallel surface 540-A and the second parallel surface 540-B increases.

The first bending portion 550-A and the second bending portion 550-B can prevent the LGP 100 from being damaged (e.g., scratched or scraped) when the LGP 100 is inserted into the housing 501.

In addition, since the first bending portion 550-A and the second bending portion 550-B can have elasticity, a height of the open side portion 620 can be increased when the LGP 100 is inserted into the housing 501. Therefore, the LGP 100 can be stably inserted into the housing 501.

The first cover 700-A and the second cover 700-B may be coupled to the open portions 610 at both sides of the housing 501 to prevent the height of the open side portion 620 from being increased to more than a predetermined height. In addition, the first cover 700-A and the second cover 700-B may apply certain pressure to the first bending portion 550-A and the second bending portion 550-B. Therefore, when the LGP 100 is inserted into the housing 501, the first bending portion 550-A and the second bending portion 550-B may be bent to increase the height of the open side portion 620, thereby enabling the LGP 100 to be easily inserted into the housing 501. However, after the LGP 100 is inserted into the housing 501, the first bending portion 550-A and the second bending portion 550-B may, by their elasticity, apply pressure to the LGP 100 from above and under the LGP 100, thereby preventing the movement of the LGP 100.

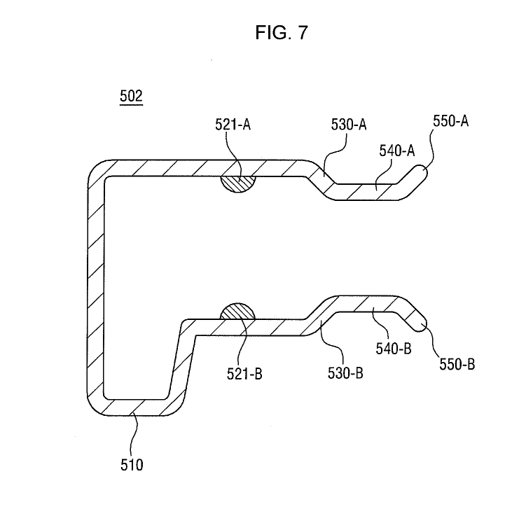

FIG. 7 is a cross-sectional view of a housing or light source cover 502 according to another embodiment of the present invention. Referring to FIG. 7, an upper support portion 521-A and a lower support portion 521-B formed on the housing 502 may be made of a different member from the housing 502. The different member may be an elastic member such as rubber or silicon-based resin. The upper support portion 521-A and the lower support portion 521-B made of the elastic member can prevent the quantum dot bar 400 from being damaged by external impact.

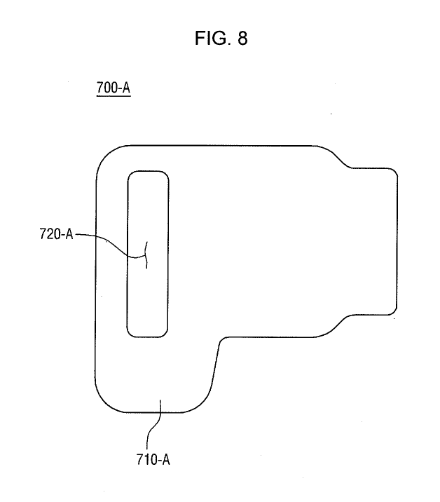

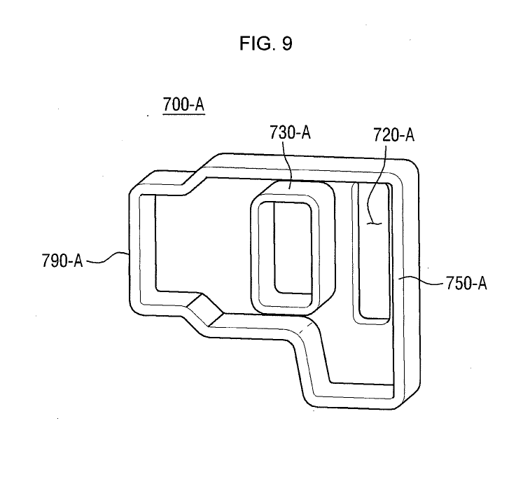

FIGS. 8 and 9 are rear and front views of the first cover 700-A according to an embodiment of the present invention. The first cover 700-A will now be described in greater detail with reference to FIGS. 8 and 9.

Referring to FIGS. 8 and 9, the first cover 700-A may include an intaglio shape corresponding to the vertical cross-sectional shape of the housing 500. Therefore, the first cover 700-A may be coupled to the housing 500 while covering an open portion 610 of the housing 500. Since the open portion 610 is not exposed, the leakage of light through the open portion 610 can be prevented.

The first cover 700-A may include the first coupling portion 730-A which can be coupled to the quantum dot bar 400. The first coupling portion 730-A may be coupled and fixed to one of both ends of the quantum dot bar 400 in the lengthwise direction of the quantum dot bar 400. Therefore, the quantum dot bar 400 having an end coupled to the first cover 700-A may be inserted into the housing 500. In addition, the other end of the quantum dot bar 400 may be coupled and fixed to the second cover 700-B. Therefore, both ends of the quantum dot bar 400 may be supported by the first cover 700-A and the second cover 700-B.

Although not illustrated in the drawings, the first cover 700-A and the housing 500 can be coupled to each other in various ways other than the above-described way. For example, protruding portions having elasticity may be formed on and under the first cover 700-A, and holes that can be coupled to the protruding portions may be formed at locations, which correspond to the protruding portions, inside the housing 500. Then, pressure may be applied to couple the first cover 700-A and the housing 500 to each other. Alternatively, the housing 500 and the first cover 700-A may be coupled to each other by hooks or protrusions and recesses ( [symbol] ).

The first cover 700-A may include the through hole 720-A through which a portion of the circuit board 300 can pass. A portion of the circuit board 300 may be inserted into the through hole 720-A. As will be described later, a connector may be formed on an exposed portion of the circuit board 300 and connected to an external circuit. Another through hole 720-B may also be formed in the second cover 700-B. Thus, the circuit board 300 may be supported at both ends thereof. The shape of the through hole 720-A may correspond to a cross-sectional shape of the circuit board 300 or may be larger than the cross-sectional shape of the circuit board 300.

The shape of the first cover 700-A may vary according to the cross-sectional shape of a portion of the housing 500 which is coupled to the first cover 700-A. For example, if the housing 500 includes the first bent surface 530-A and the second bent surface 530-B, the first parallel surface 540-A and the second parallel surface 540-B, or the first bending portion 550-A and the second bending portion 550-B, the cross-section of the first cover 700-A may have a corresponding intaglio shape such that the first cover 700-A can be coupled to the housing 500.

The first cover 700-A may include a blocking surface 790-A to partially block the open side portion 620 of the housing 500. In addition, the second cover 700-B may include a blocking surface 790-B to partially block the open side portion 620. That is, the blocking surfaces 790-A and 790-B of the first cover 700-A and the second cover 700-B may be formed to partially block both ends of a surface formed by the open side portion 620.

The LGP 100 may include an insertion portion which is inserted into the open side portion 620 and a step which causes the other portion of the LGP 100 to be wider than the open side portion 620. That is, a step may be formed in the LGP 100 such that the LGP 100 has different widths. Accordingly, the other portion of the LGP 100 may be wider than the insertion portion inserted into the open side portion 620.

The blocking surfaces 790-A and 790-B and the relationship between the open side portion 620 and the LGP 100 formed by the blocking surfaces 790-A and 790-B will now be described in greater detail with reference to FIG. 1.

Referring to FIG. 1, the blocking surfaces 790-A and 790-B may partially block both ends of the open side portion 620, and the LGP 100 may be inserted into an unblocked portion (i.e., an open portion) of the open side portion 620. The LGP 100 may include an insertion portion 110 (see FIG. 5) which is inserted into the open side portion 620, and a width W1 of the insertion portion 110 may be equal to or smaller than a width W2 of the open portion of the open side portion 620 which is not blocked by the blocking surfaces 790-A and 790-B. Therefore, the insertion portion 110 of the LGP 100 can be inserted into the housing 500 through the open side portion 620.

The LGP 100 may have a step 130 (see FIG. 5) that causes the LGP 100 to include a portion having a greater width W3 than the width W2 of the open portion of the open side portion 620. The portion of the LGP 100 having the greater width W3 may be referred to as a non-insertion portion 120. Since the non-insertion portion 120 has the width W3 greater than the width W2 of the open portion of the open side portion 620, it cannot be inserted into the housing 500. In addition, since the open side portion 620 is partially blocked by the blocking surfaces 790-A and 790-B and the insertion of the non-insertion portion 120 into the housing 500 is prevented by the step 130 of the LGP 100, only the insertion portion 110 of the LGP 100 can be inserted into the housing 500 and fixed to and supported by the housing 500. Accordingly, it is possible to prevent the insertion of the non-insertion portion 120 of the LGP 100 deep into the housing 500, thereby preventing the damage to the quantum dot bar 400 inside the housing 500.

The blocking surfaces 790-A and 790-B may guide the insertion portion 110 of the LGP 100 to be accurately inserted into the open portion of the open side portion 620. In addition, the step 130 of the LGP 100 allows the insertion portion 110 of the LGP to be inserted into the housing 500 by an exact distance. Thus, the LGP 100 can be aligned accurately.

Although the second cover 700-B is not specifically described herein, it may have the same shape as the first cover 700-A or may be a mirror shape of the first cover 700-A. The second cover 700-B can be formed by combining various elements of the first cover 700-A. Therefore, a detailed description of the second cover 700-B is omitted.

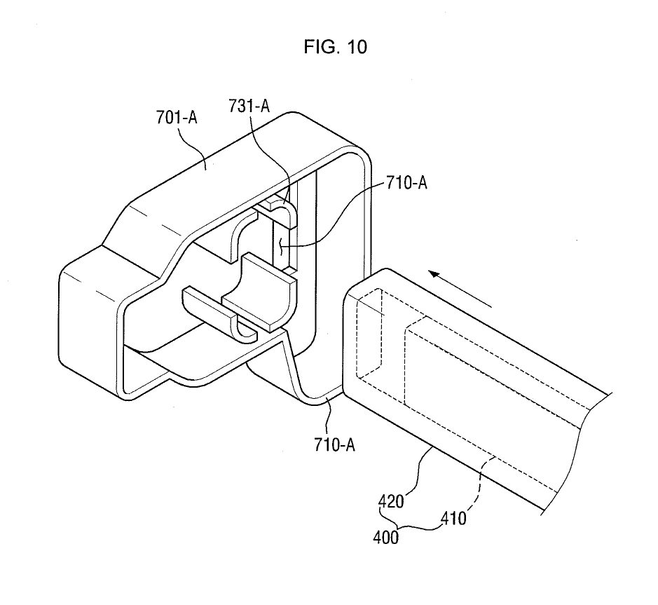

FIG. 10 is a perspective view of a first cover 701-A according to another embodiment of the present invention. Referring to FIG. 10, a first coupling portion 731-A which is coupled to the quantum dot bar 400 may be formed such that it can fix four corners of an end of the quantum dot bar 400. Although not illustrated in the drawing, the first coupling portion 731-A may also fix the quantum dot bar 400 by applying pressure to the end of the quantum dot bar 400 from both sides. The way the first coupling portion 731-A fixes the quantum dot bar 400 is not limited to a particular way.

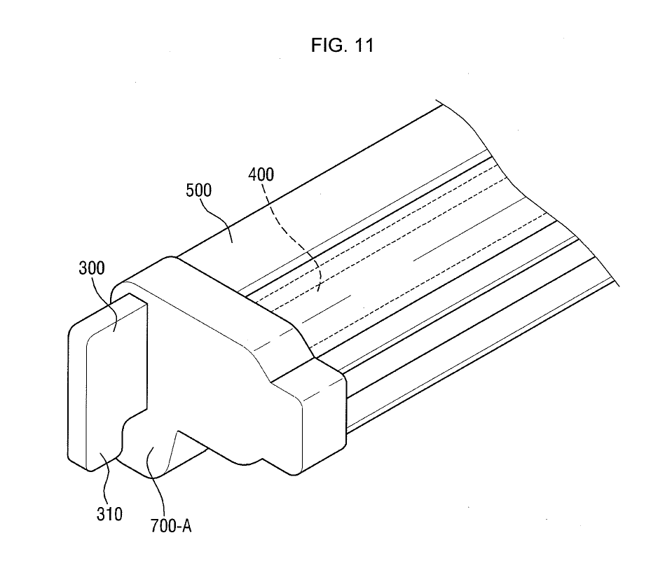

FIG. 11 is a partial perspective view of a backlight unit according to another embodiment of the present invention.

Referring to FIG. 11, a portion of a circuit board 300 may pass through a through hole 720-A or 720-B of a first cover 700-A or a second cover 700-B to be exposed. The exposed portion of the circuit board 300 may include a connector 310 for electrically connecting an external circuit (not shown) and the circuit board 300. Therefore, even if the circuit board 300 is placed inside a housing 500, it can be connected to the external circuit by the connector 310. The external circuit connected to the connector 310 may be, but is not limited to, an FPCB. In FIG. 11, the connector 310 extends downward from the circuit board 300. However, the present invention is not limited thereto, and the connector 310 may also extend in a direction in which an LGP is disposed or may extend upward from the circuit board 300. That is, the shape of the connector 310 can be changed as desired.

FIG. 12 is a cross-sectional view of a backlight unit according to another embodiment of the present invention. Referring to FIG. 12, a housing 500 may include a first guide groove 525-A and a second guide groove 525-B which guide a quantum dot bar 400 to be placed therein. The first guide groove 525-A may be disposed on an upper surface of the quantum dot bar 400, and the second guide groove 525-B may be disposed on a lower surface of the quantum dot bar 400.

That is, the first guide groove 525-A and the second guide groove 525-B may be recessed upward and downward in a shape corresponding to a shape of the quantum dot bar 400 at a location where the quantum dot bar 400 is disposed. Therefore, as the quantum dot bar 400 is placed in the first guide groove 525-A and the second guide groove 525-B, it can be positioned exactly at a desired location.

In addition, the first guide groove 525-A and the second guide groove 525-B may be recessed by a distance that allows only a quantum dot material 410 inside the quantum dot bar 400 to be placed on an optical path. In other words, the first guide groove 525-A and the second guide groove 525-B may be formed such that the quantum dot material 410 contained in the quantum dot bar 400 is placed higher than the first guide groove 525-A and lower than the second guide groove 525-B. Accordingly, most of light emitted from one or more light-emitting devices 200 may pass through the quantum dot material 410 and may be converted into white light by the quantum dot material 410.

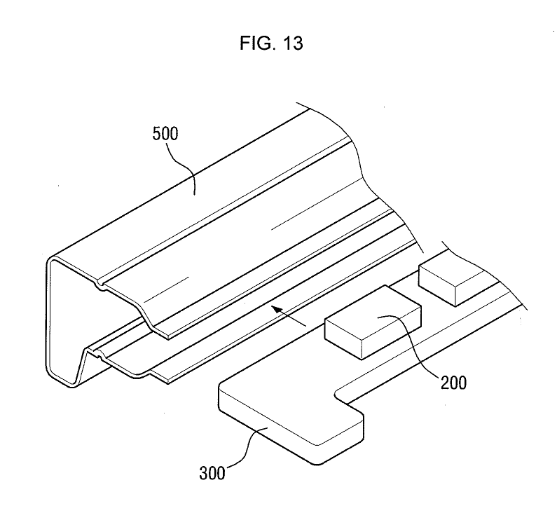

FIGS. 13 through 21 are views illustrating a process of assembling a backlight unit according to an embodiment of the present invention. The process of assembling the backlight assembly will now be described with reference to FIGS. 13 through 21.

Referring to FIG. 13, a light source module and a housing 500 are prepared. The light source module includes a plurality of light-emitting devices 200 which are arranged on a circuit board 300 to be separated from each other in a direction and are electrically connected to the circuit board 300. Next, the circuit board 300 having the light-emitting devices 200 mounted thereon is inserted into the housing 500 through an open side portion 620 of the housing 500. An adhesive member (not shown) for attaching the circuit board 300 to the housing 500 may be attached to a rear surface of the circuit board 300, that is, a surface of the circuit board 300 opposite a surface on which the light-emitting devices 200 are arranged. To make the insertion of the circuit board 300 easy, the circuit board 300 may be rotated such that the light-emitting devices 200 face upward. In this state, the circuit board 300 may be inserted into the housing 500.

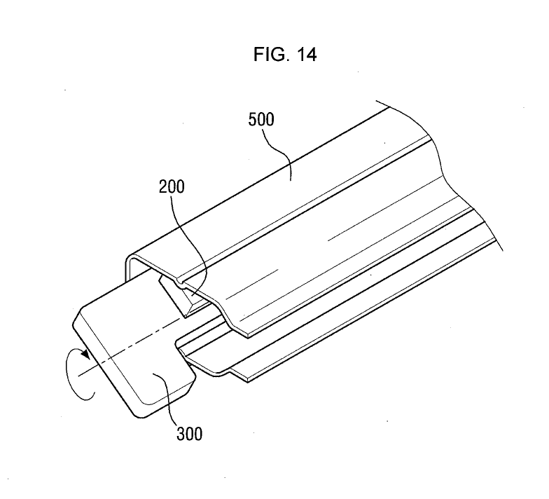

Referring to FIG. 14, the inserted circuit board 300 may be rotated to attach the circuit board 300 to an inner side surface of the housing 500. The housing 500 includes a protruding portion which protrudes downward, and, accordingly, an empty space protruding downward is formed inside the housing 500. Therefore, the circuit board 300 can be rotated easily.

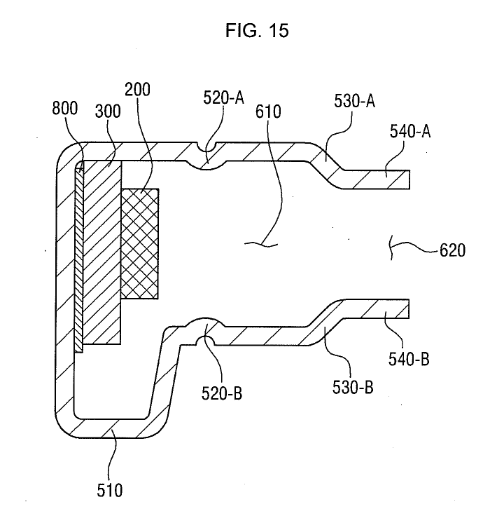

FIG. 15 is a cross-sectional view of the circuit board 300 attached to the inside of the housing 500. Referring to FIG. 15, the circuit board 300 may be attached to an upper part of the inner side surface of the housing 500 by an adhesive member 800. Therefore, the light-emitting devices 200 may face a side of the open side portion 620.

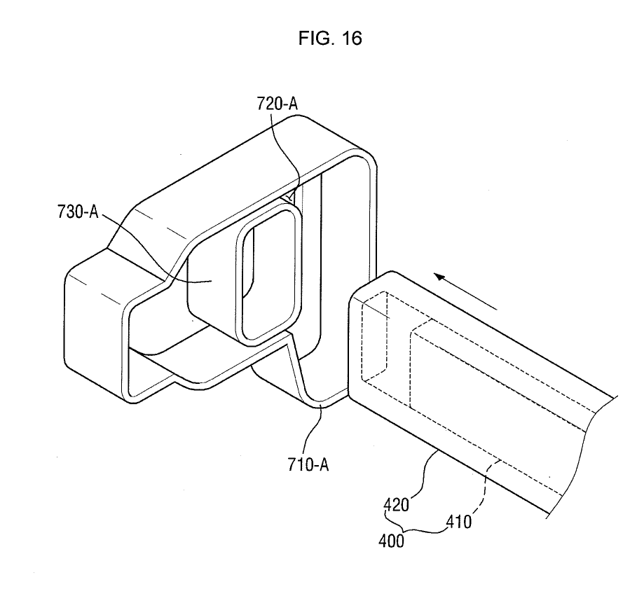

Referring to FIG. 16, a quantum dot bar 400 may be coupled to a first coupling portion 730-A of a first cover 700-A. The first coupling portion 730-A may include an intaglio groove corresponding to a vertical cross-sectional shape of the quantum dot bar 400 so as to couple the quantum dot bar 400 thereto. An end of the quantum dot bar 400 may be coupled and fixed to the first coupling portion 730-A.

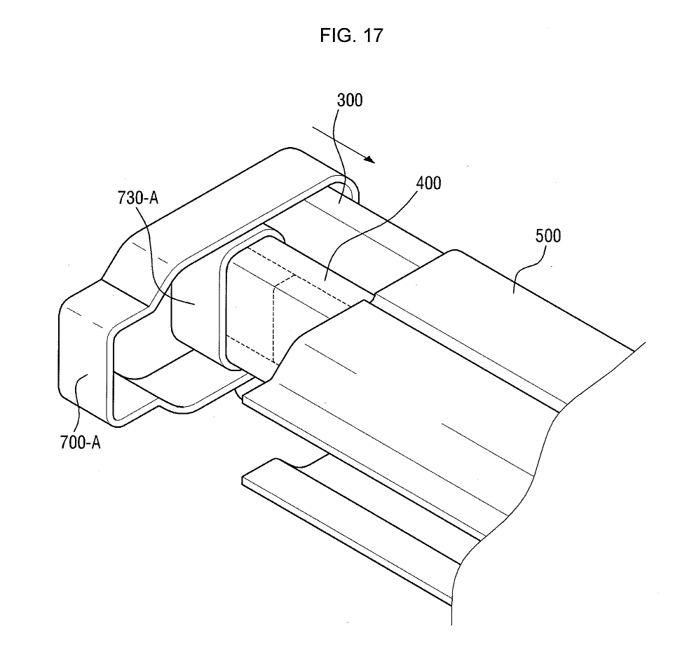

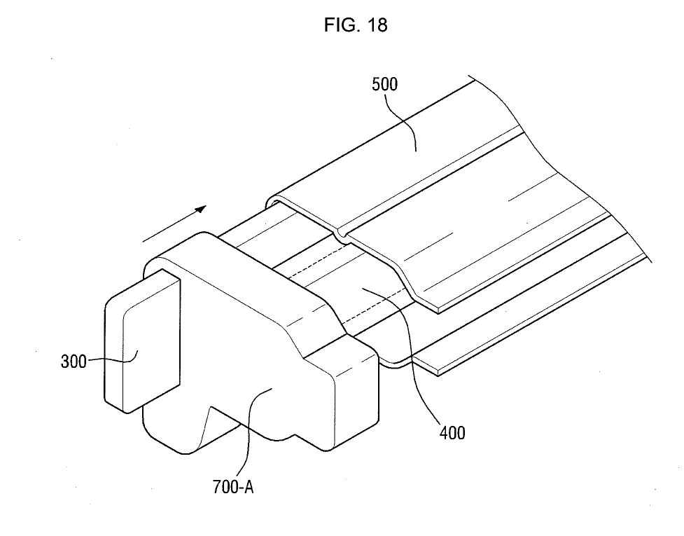

Referring to FIGS. 17 and 18, the first cover 700-A to which the quantum dot bar 400 is coupled may be coupled to the housing 500. The quantum dot bar 400 may be inserted into the housing 500 by pushing the quantum dot bar 400 from left to right. In addition, since the first cover 700-A includes a through hole 720-A, a portion of the circuit board 300 already attached to the housing 500 may pass through the through hole 720-A to be exposed.

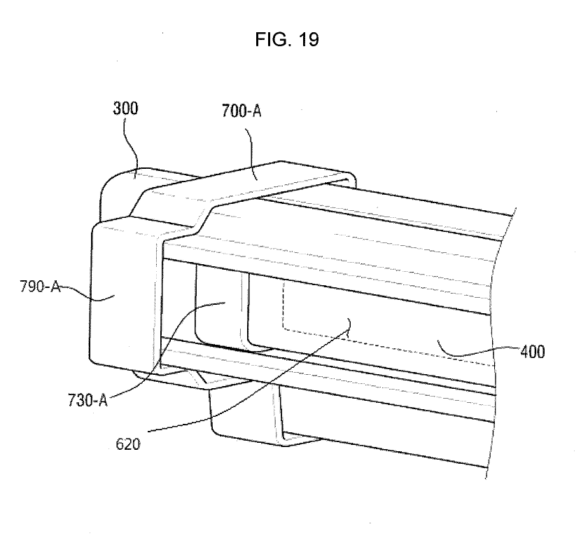

FIG. 19 is a perspective view of the housing 500 and the first cover 700-A coupled onto the housing 500. Referring to FIG. 19, the quantum dot bar 400 may be placed inside the housing 500, and a portion of the circuit board 300 may protrude out of the first cover 700-A. In addition, a portion of the open side portion 620 may be blocked by a first blocking surface 790-A.

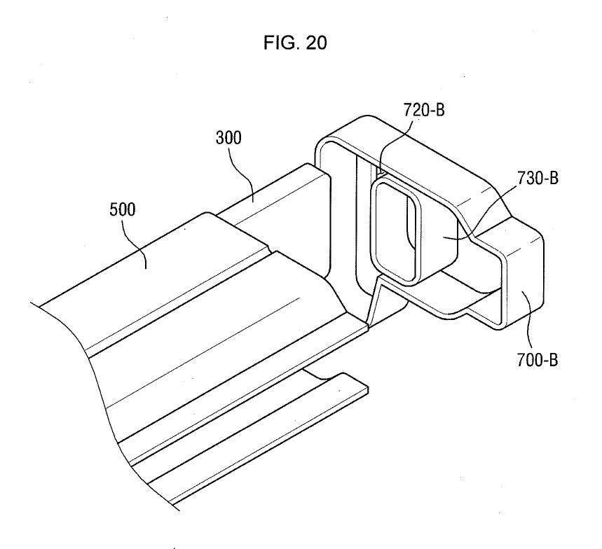

Referring to FIG. 20, a second cover 700-B may be coupled to a surface of the housing 500 which is opposite a surface to which the first cover 700-A is coupled. The second cover 700-B may include a through hole 720-B, and a portion of the circuit board 300 may pass through the through hole 720-B. The quantum dot bar 400 may be fixed and coupled to the second cover 700-B by a second coupling portion 730-B.

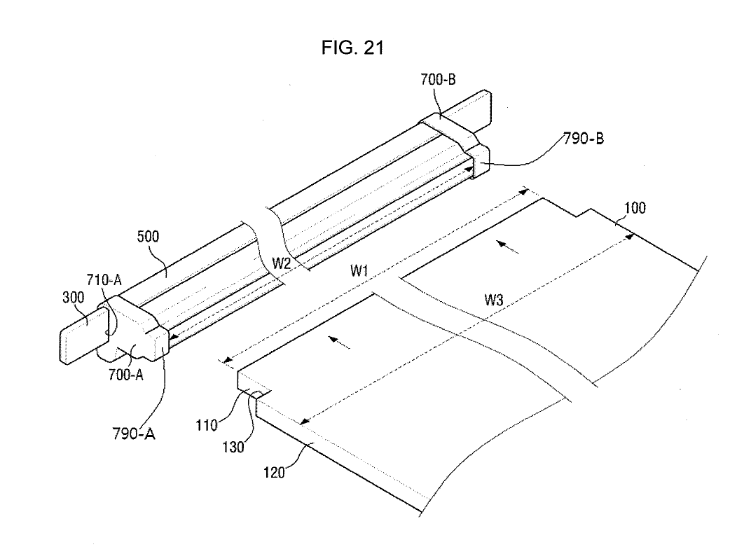

Referring to FIG. 21, an LGP 100 may be inserted into an open portion of the open side portion 620. The LGP 100 may include a non-insertion portion 120 having a greater width W3 than a width W2 of the open portion of the open side portion 620. Therefore, only an insertion portion 110 of the LGP 100 may be inserted into the housing 500.

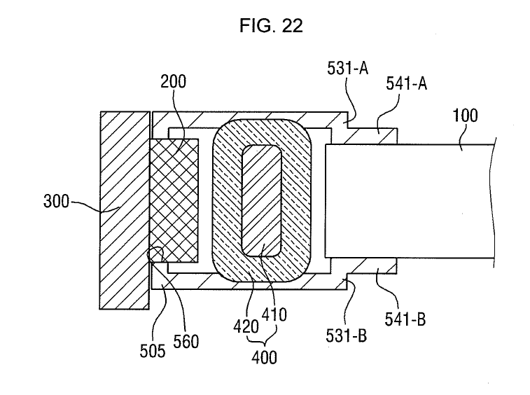

FIG. 22 is a cross-sectional view of a backlight unit according to another embodiment of the present invention. Referring to FIG. 22, the backlight unit may include an LGP 100; one or more light-emitting devices 200 which are disposed on a side of the LGP 100 and generate light; a circuit board 300 which is electrically connected to the light-emitting devices 200; a quantum dot bar 400 which is interposed between the LGP 100 and the light-emitting devices 200 and converts a wavelength of light; a housing or light source cover 505 which houses the quantum dot bar 400 and includes open portions 610 formed at both ends thereof in a lengthwise direction of the quantum dot bar 400, an open side portion 620 into which a portion of the LGP 100 is inserted, and one or more incident windows 560 respectively corresponding to the light-emitting devices 200; and a first cover (not shown) and a second cover (not shown) which cover the open portions 610 at both ends of the housing 505 and are coupled to the housing 505. The first cover (not shown) and the second cover (not shown) may respectively include a first coupling portion (not shown) and a second coupling portion (not shown) which are coupled to both sides of the quantum dot bar 400. The light-emitting devices 200 may be inserted into the incident windows 560.

In addition, the housing 505 may include a first bent surface 531-A which extends from above the LGP 100 toward the LGP 100, a second bent surface 531-B which extends from under the LGP 100 toward the LGP 100, a first parallel surface 541-A which is connected to the first bent surface 531-A and parallel to the LGP 100, and a second parallel surface 541-B which is connected to the second bent surface 531-B and parallel to the LGP 100. The first parallel surface 541-A and the second parallel surface 541-B may contact the LGP 100.

That is, in the backlight unit of FIG. 22, the circuit board 300 is located outside the housing 505, and the light-emitting devices 200 are inserted into the incident windows 560. Other elements of the backlight unit are identical to those described above, and thus a redundant description thereof is omitted.

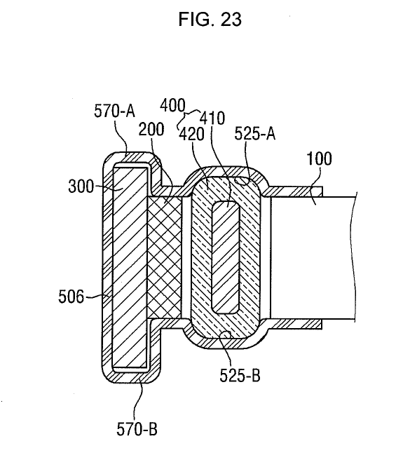

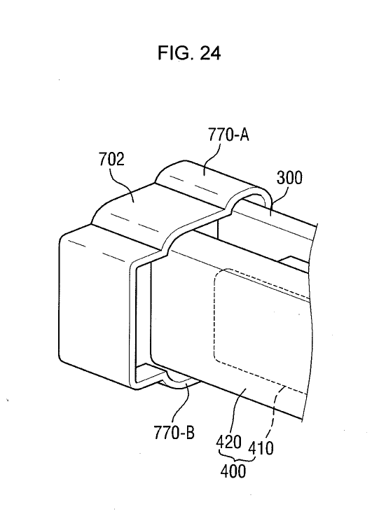

FIGS. 23 and 24 are cross-sectional and perspective views of a backlight unit according to another embodiment of the present invention. Referring to FIGS. 23 and 24, the backlight unit may include a circuit board 300; a plurality of light-emitting devices 200 which are electrically connected to the circuit board 300 and arranged in a direction of the circuit board 300; an LGP 100 which includes a side facing the light-emitting devices 200; a quantum dot bar 400 which is interposed between the light-emitting devices 200 and the LGP 100 and converts a wavelength of light; a housing 506 which fixes and houses the circuit board 300, houses the quantum dot bar 400, and includes open portions formed at both ends thereof in a lengthwise direction of the quantum dot bar 400 and an open side portion into which a portion of the LGP 100 is inserted; and a first cover 702-A and a second cover (not shown) which cover the open portions at both ends of the housing 506 and are coupled to the housing 506. The first cover 702-A and the second cover (not shown) may respectively include a first coupling portion (not shown) and a second coupling portion (not shown) which are coupled to both sides of the quantum dot bar 400.

In addition, the housing 506 may include a first guide groove 525-A and a second guide groove 525-B which guide the quantum dot bar 400 to be placed therein. Since the first guide groove 525-A and the second guide groove 525-B have been described above, a more detailed description thereof is omitted.

The housing 506 may include a fixing portion (570-A, 570-B) which fixes the circuit board 300 to the housing 506. The circuit board 300 placed inside the housing 506 may be fixed and coupled to the housing 506 by the fixing portion (570-A, 570-B). Therefore, the circuit board 300 can be fixed to the inside of the housing 506 without using an adhesive member.

The fixing portion (570-A, 570-B) may include a first hook 570-A which is disposed on an upper surface of the circuit board 300 to cover the circuit board 300 and a second hook 570-B which is disposed on a lower surface of the circuit board 300 to cover the circuit board 300. The circuit board 300 may be fixed to the inside of the housing 506 by the first hook 570-A and the second hook 570-B. In other words, the first hook 570-A may be bent downward in a hook shape to cover an upper part of the circuit board 300, and the second hook 570-B may be bent upward in a hook shape to cover a lower part of the circuit board 300.

Referring to FIG. 24, the first cover 702-A coupled to the housing 506 may have a shape corresponding to the shape of the fixing portion (570-A, 570-B) of the housing 506. Therefore, the first cover 702-A may include an upwardly protruding portion 770-A at a location where the circuit board 300 is disposed. Although the second cover is not illustrated in the drawings, it may have the same shape as the first cover 702-A or may be a mirror shape of the first cover 702-A. Since the second cover is identical to the first cover 702-A, a more detailed description thereof is omitted.

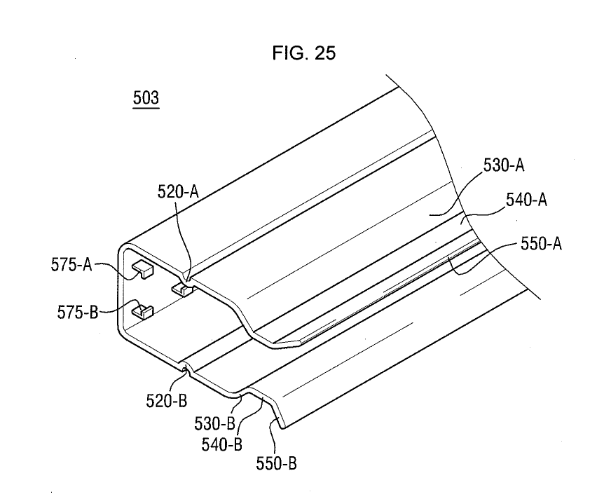

FIG. 25 is a partial perspective view of a housing or light source cover 503 according to another embodiment of the present invention. Referring to FIG. 25, a plurality of first fixing portions 575-A and a plurality of second fixing portions 575-B may be formed on an inner surface of the housing 503. The first fixing portions 575-A and the second fixing portions 575-B may be arranged at regular intervals along the inner surface of the housing 503 or may be formed at both ends of the housing 503 to support both ends of a circuit board 300. The first and second fixing portions 575-A and 575-B may be bent to a length at which they do not contact one or more light-emitting devices 200 disposed on a circuit board 300. The first fixing portions 575-A and the second fixing portions 575-B can be transformed into various shapes.

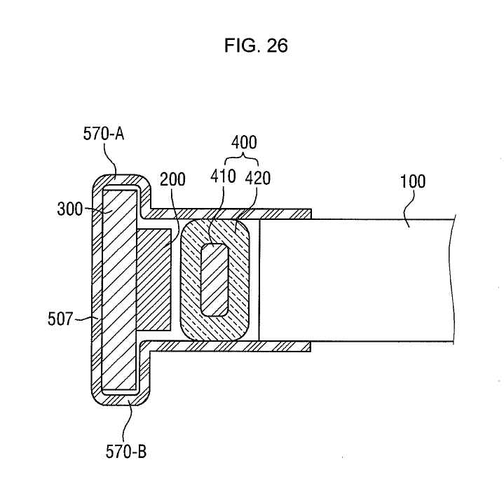

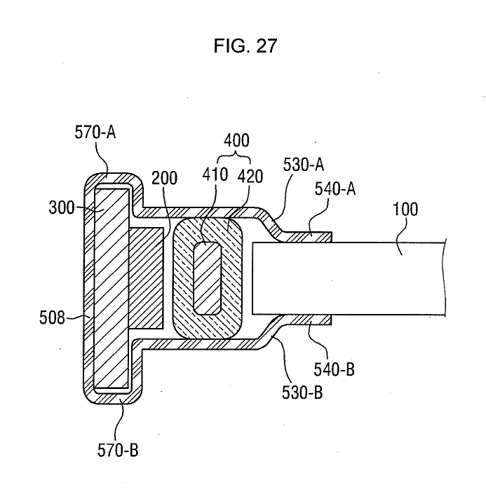

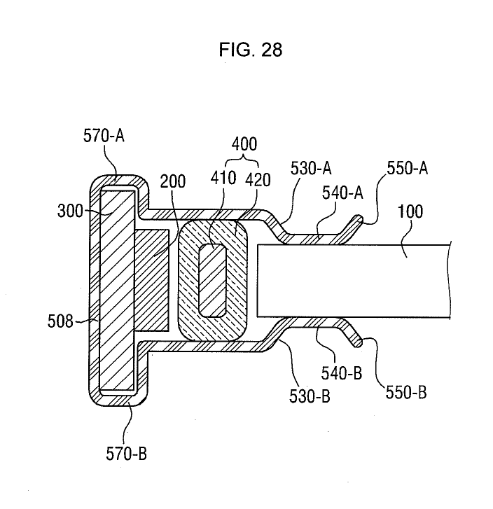

FIGS. 26 through 28 illustrate backlight units according to modified embodiments of the present invention. Specifically, a backlight unit of FIG. 26 is the same as the backlight unit of FIG. 23 except that it does not include the first guide groove 525-A and the second guide groove 525-B of the backlight unit of FIG. 23 and that a gap between a housing 507 and one or more light-emitting devices 200 is different from the gap between the housing 506 and the light-emitting devices 200 in FIG. 23. A backlight of FIG. 27 is the same as the backlight unit of FIG. 26 except that it additionally includes a first bent surface 530-A, a second bent surface 530-B, a first parallel surface 540-A and a second parallel surface 540-B. A backlight unit of FIG. 28 is the same as the backlight unit of FIG. 27 except that it additionally includes a first bending portion 550-A and a second bending portion 550-B. As in FIGS. 26 through 28, different elements described above can be combined in various ways.

Although not illustrated in the drawings, a housing may include a downward protrusion that can fix and couple the housing to the bottom chassis, and the bottom chassis may include a coupling hole that can be coupled to the protrusion. Therefore, the housing and the bottom chassis can be coupled to each other by the protrusion and the coupling hole. In addition, the protrusion and the coupling hole may be provided in a plurality, and the protrusions and the coupling holes may be arranged at regular intervals. Therefore, the housing can be stably fixed onto the bottom chassis by the protrusions and the coupling holes.

A reflective sheet may further be provided on a rear surface of an LGP, that is, between the LGP and the bottom surface of the bottom chassis. The reflective sheet may reflect light emerging from the rear surface of the LGP in a direction toward a front surface of the LGP, thereby increasing the efficiency of the light.

The housing may be made of a light-reflecting member such as polycarbonate (PC), a mixture of polycarbonate resin and acrylonitrile-butadiene-styrene copolymer resin, or a mixture of polycarbonate resin and glass fiber (G/F).

In addition, the housing may be made of a light-reflecting metal material such as aluminum (Al). Since the metal material has a high heat transfer rate, it may dissipate heat generated inside the light source cover, thereby preventing the degradation of a quantum dot material inside the housing and a reduction in the efficiency of the quantum dot material due to the degradation of the quantum dot material.

A first cover and a second cover may be made of the same material as the light source cover.

In a backlight unit according to embodiments of the present invention, one or more light-emitting devices, the quantum dot bar, and a portion of the LGP are all located inside the housing formed as a single piece. Therefore, the backlight unit according to embodiments of the present invention can minimize the leakage of light. In addition, since a reflection cycle inside the housing increases, light-emission efficiency increases, and a uniform distribution of light can be provided to the LGP.

A display device including the backlight unit according to embodiments of the present invention and other elements will now be described.

The backlight unit according to embodiments of the present invention may be disposed on one sidewall or both facing sidewalls of a bottom chassis in the display device. Alternatively, the backlight unit may be disposed on an adjacent sidewall. That is, the location of the backlight unit is not limited to a particular location.

In the display device, optical sheets such as a diffusion film, a prism film, and a protective film may be stacked on the LGP in order to improve the optical performance of the display device. The diffusion film may diffuse light emerging from the LGP and provide the diffused light to a display panel. The prism film may focus light diffused by the diffusion film in a direction perpendicular to a flat surface of the display panel thereabove. In addition to the diffusion film and the prism film, a microlens array film, a lenticular lens film, etc. can be used. For example, a number of optical sheets may be used repeatedly, or the arrangement of the optical sheets may be changed as desired by those of ordinary skill in the art to which the present invention pertains.

A middle frame may be stacked on the optical sheets, and the display panel for displaying an image may be placed on the middle frame. In addition, a top chassis which partially covers the display panel and includes a window may be stacked on the display panel. The display panel may include a liquid crystal layer interposed between a thin-film transistor (TFT) substrate and a color filter and include a polarizing filter and a driver IC. The display panel may display an image by adjusting the intensity of light received from the backlight unit.

The optical sheets and the display panel are widely known to those of ordinary skill in the art, and thus a more detailed description thereof is omitted.

However, the effects of the present invention are not restricted to the one set forth herein. The above and other effects of the present invention will become more apparent to one of daily skill in the art to which the present invention pertains by referencing the claims.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A backlight unit comprising:
a light guide plate (LGP);
one or more light-emitting devices disposed to face a side of the LGP and configured to generate light;
a circuit board electrically connected to the one or more light-emitting devices;
a quantum dot bar interposed between the LGP and the one or more light-emitting devices and configured to convert a wavelength of light;
a housing configured to house the one or more light-emitting devices, the circuit board and the quantum dot bar, and comprising first and second open end portions and an open side portion through which a portion of the LGP is inserted; and
first and second covers covering the first and second open end portions of the housing, respectively, and coupled to the housing,
wherein the first cover and the second cover respectively comprise a first coupling portion and a second coupling portion which are coupled to first and second ends of the quantum dot bar, respectively.

2. The backlight unit of claim 1, further comprising an adhesive member which is interposed between the circuit board and the housing to couple the circuit board and the housing.

3. The backlight unit of claim 1, wherein at least one of the first cover and the second cover comprises a through hole through which a portion of the circuit board pass, wherein the portion of the circuit board protrudes out of the at least one of the first cover and the second cover.

4. The backlight unit of claim 1, wherein each of the first cover and the second cover comprises a recessed shape corresponding to a vertical cross-sectional shape of a portion of the housing which is coupled to each of the first cover and the second cover.

5. The backlight unit of claim 1, wherein the housing comprises a protruding portion which protrudes downward to provide a space within the housing such that the circuit board can rotate in the space.

6. The backlight unit of claim 1, wherein the housing further comprises an upper support portion and a lower support portion which protrude inward, wherein the upper support portion and the lower support portion protrude toward the quantum dot bar from above and under a location where the quantum dot bar is disposed, wherein the upper support portion and the lower support portion contact the quantum dot bar.

7. The backlight unit of claim 1, wherein the housing has a length and a sectional shape taken in a plane perpendicular to its length direction is uniform throughout the length.

8. The backlight unit of claim 7, wherein the housing comprises an upper inner surface and a lower inner surface which contact upper and lower surfaces of the quantum dot bar such that a substantial amount of light does not transmit between the upper inner surface of the housing and the upper surface of the quantum dot bar and between the lower inner surface of the housing and the lower surface of the quantum dot bar.

9. The backlight unit of claim 6, wherein the housing comprises an upper groove and a lower groove extending in a length direction of the housing and comprising the upper inner surface and the lower inner surface, respectively.

10. The backlight unit of claim 6, wherein the housing comprises an upper protrusion and a lower protrusion protruding toward the quantum dot bar, extending in a length direction of the housing and comprising the upper inner surface and the lower inner surface, respectively.

11. The backlight unit of claim 1, wherein the housing comprises a first bent surface and a second bent surface which extend inward toward the LGP, wherein the first bent surface extends from above the LGP toward an upper surface of the LGP, and the second bent surface extends from under the LGP toward a lower surface of the LGP.

12. The backlight unit of claim 11, wherein the housing comprises:
a first parallel surface which is connected to the first bent surface and parallel to the LGP;
a second parallel surface which is connected to the second bent surface and parallel to the LGP;
a first bending portion which is connected to the first parallel surface and extends outward of the housing; and
a second bending portion which is connected to the second parallel surface and extends outward of the housing,
wherein the first parallel surface and the second parallel surface contact the LGP.

13. The backlight unit of claim 1, wherein the housing comprises a first guide groove and a second guide groove which guide the quantum dot bar to be placed therein, wherein the first guide groove is disposed on an upper surface of the quantum dot bar, and the second guide groove is disposed on a lower surface of the quantum dot bar.

14. The backlight unit of claim 1, wherein the LGP comprises an insertion portion which is inserted into the open side portion and a step which causes the other portion of the LGP to be wider than the open side portion.

15. A backlight unit comprising:
a light guide plate (LGP);
one or more light-emitting devices disposed to face a side of the LGP and configured to generate light;
a circuit board electrically connected to the one or more light-emitting devices;
a quantum dot bar interposed between the LGP and the one or more light-emitting devices and configured to convert a wavelength of light;
a housing configured to house the quantum dot bar and comprises first and second open end portions, an open side portion through which a portion of the LGP is inserted, and one or more incident windows respectively corresponding to the one or more light-emitting devices; and
a first cover and a second cover covering the first and second open end portions, respectively, and coupled to the housing,
wherein the first cover and the second cover respectively comprise a first coupling portion and a second coupling portion which are coupled to first and second ends of the quantum dot bar, respectively, and wherein the one or more light-emitting devices are respectively inserted into the one or more incident windows.

16. The backlight unit of claim 15, wherein the housing comprises:
a first bent surface which extends from above the LGP toward an upper surface of the LGP;
a second bent surface which extends from under the LGP toward a lower surface of the LGP;
a first parallel surface which is connected to the first bent surface and parallel to the LGP; and
a second parallel surface which is connected to the second bent surface and parallel to the LGP,
wherein the first parallel surface and the second parallel surface contact the LGP.

17. A backlight unit comprising:
a circuit board;
a plurality of light-emitting devices electrically connected to the circuit board and arranged along a length direction of the circuit board;
an light guide plate (LGP) comprising a side facing the plurality of light-emitting devices;
a quantum dot bar interposed between the light-emitting devices and the LGP and configured to convert a wavelength of light;
a housing configured to house the circuit board and the quantum dot bar, and comprising first and second open end portions and an open side portion through which a portion of the LGP is inserted; and
a first cover and a second cover covering the first and second open end portions, respectively, and coupled to the housing,
wherein the first cover and the second cover respectively comprise a first coupling portion and a second coupling portion coupled to both ends of the quantum dot bar, respectively.

18. The backlight unit of claim 17, wherein the housing comprises a first guide groove and a second guide groove which guide the quantum dot bar to be placed therein, wherein the first guide groove is disposed on an upper surface of the quantum dot bar, and the second guide groove is disposed on a lower surface of the quantum dot bar.

19. The backlight unit of claim 17, wherein the housing comprises a fixing portion which fixes the circuit board to the housing.

20. The backlight unit of claim 19, wherein the fixing portion comprises a first hook which is disposed on an upper surface of the circuit board to cover the circuit board and a second hook which is disposed on a lower surface of the circuit board to cover the circuit board.
